(19) United States
(12) Patent Application Publication
(10) Pub. No.: US 2010/0095061 A1
(43) Pub. Date: Apr. 15, 2010

(54) SYSTEM ON A CHIP (SOC) AND SYSTEM IN A PACKAGE (SIP) SYSTEM FOR CONCURRENT STORAGE AND ARCHIVAL OF IMAGES AND DOCUMENTS

(76) Inventor: Ponnathpur R. Mukund, Penfield, NY (US)

Correspondence Address: HISCOCK & BARCLAY, LLP, 2000 HSBC PLAZA, 100 Chestnut Street, ROCHESTER, NY, 14604-2404, US

(21) Appl. No.: 12/576,271

(22) Filed: Oct. 9, 2009

Related U.S. Application Data
(60) Provisional application No. 61/104,612, filed on Oct. 10, 2008.

(51) Int. Cl. G06F 12/00; G06F 12/16

(52) U.S. Cl. 711/115; 711/162; 711/E12.001; 711/E12.103

(57) ABSTRACT

A device for combining the storage and archival of digital and analog data representing images and documents. The archival is accomplished by the imaging the top metal layer on a wafer or substrate that represents the data that can be extracted by optical methods. The storage is accomplished by memory device(s) that are embedded either in the same wafer or substrate that contains the archival data or in the same package that contains the said wafer or substrate. The storage data can be extracted by means of a connector as digital data that can be interfaced to a computer. The stored data accurately represents the archived data so that the stored and archived data are reasonably similar in nature.

### CROSS-REFERENCE TO RELATED APPLICATIONS

This application claims priority from U.S. Provisional Patent Application Ser. No. 61/104,612, filed Oct. 10, 2008.

### FIELD OF THE INVENTION

This invention relates to the long-term storage of images on substrates that can be processed using semiconductor fabrication techniques, and more particularly to the long-term storage of images on imaging substrates. The invention further relates to the high-speed retrieval of images stored on imaging substrates.

### BACKGROUND OF THE INVENTION

As unique documents are created and the desire to back-up information is increased the need to efficiently archive data increases. On an individual level, information such as letters, property papers, financial documents, photographs and such are preserved for sentimental, personal, and financial reasons. Federal institutions invest time and money to preserving legislative, executive, judicial documents, as well as birth and death records of the citizens. Historical documents are archived to retain the information stored within them as the documents deteriorate with age and become brittle. The archived copies can provide access to the information in the event the original document is lost or destroyed and can further provide multiple copies for access to numerous individual.

Due to the sheer volume of the above described data, paper-based storage is expensive and very cumbersome. Furthermore, paper is susceptible to environmental hazards such as water and fire. Paper documents do not age well with time unless great care is taken to preserve the paper. As a result, alternative storage techniques such as microfilm/microfiche and electronic memory were developed.

In the microfilm technology, images are preserved similar to the black and white photography process. This process utilizes image reduction techniques to reduce the size of images which are later exposed on to photosensitive films. These films are then preserved in a controlled environment for long-term preservation. However, this technology requires special microfilm viewers to view the images. Furthermore, high-quality hard-copy reproduction is expensive and the duplication process is difficult. In addition to these disadvantages, high-speed storage and retrieval are not possible with microfilm technology.

Another form of archiving is electronic storage. Data are stored electronically in the form of digital bits and using integrated circuits on semiconductor memory. Semiconductor memory can be broadly classified as either volatile or non-volatile. Volatile memory requires electrical power to retain information, while non-volatile memory can retain stored information even when not powered. An example of volatile memory is random access memory (RAM) used in most computers. Non-volatile memory includes semiconductor based flash memory, read-only memory (ROM) and most magnetic storage and optical disc storage such as CD ROMs and DVD ROMs. However, even though the semiconductor memory stores the data in a compact area, the data itself is processed and digitized prior to storage. The information must be converted to digital bits, which are represented in various forms depending on the medium of storage. In semiconductor memory, the digital bits are represented by different voltage levels that are stored using integrated circuits and/or capacitors. On CD ROMs, the bits are represented as “pits” and “grounds” that reflect a laser in different ways to read the CD ROM. In most semiconductor memory applications the digital bits are encoded prior to storage, and thus require a decoding technique for retrieving the data. This digitalization of data prior to storage can result in quantization losses. Furthermore, semiconductor memory depends very much on the current mainstream technology, thereby forcing the users to upgrade frequently to new types of storage media and media reading devices.

Therefore, a stable long-term image archiving system capable of storing a large number of images in a compact medium is desired.

Further, an archiving medium that is resistant to fire, water and time deterioration is desired.

Yet further, a high-speed storage and retrieval system for rapid access to images is desired.

### SUMMARY OF THE INVENTION

This invention relates to combining the storage and archival of digital and analog data representing images and documents. The archival is accomplished by the top metal layer on a wafer or substrate that represents the data that can be extracted by optical methods. The storage is accomplished by memory device(s) that are embedded either in the same wafer or substrate that contains the archival data or in the same package that contains the said wafer or substrate. The storage data can be extracted by means of a connector as digital data that can be interfaced to a computer. The stored data will accurately represent the archived data so that the extracted stored and archived data will be reasonably similar in nature. The system in a package may be either a multi-chip module in a single package, or a wafer or substrate and a printed circuit board assembly that are inside a single package.

This description distinguishes between archiving and storage. As used herein, archiving refers to retaining data or images of documents over a long period of time, including and not limited one or more centuries. Archiving requires durability and longevity, but not necessarily rapid access or rapid replication. As used herein storage refers to retaining data or images of documents over an extended period of time along with rapid access to stored data or documents. Storage contemplates a duration and longevity in terms of years or decades and access time less than a week. For example, copies of personal bank checks, wills, closed legal matters, may be stored for a number of years and are often stored at off-site storage facilities such as Iron Mountain. Documents such as the Declaration of Independence, the Dead Sea Scrolls, and copies of such documents are archived.

### BRIEF DESCRIPTION OF THE DRAWINGS

The present invention is disclosed with reference to the accompanying drawings, wherein:

FIG. 1 is a view of a system in a package according to one embodiment;

FIG. 2 is a view of a system on a chip according to another embodiment;

Corresponding reference characters indicate corresponding parts throughout the several views. The examples set out herein illustrate several embodiments of the invention but should not be construed as limiting the scope of the invention in any manner.

### DETAILED DESCRIPTION

One embodiment comprises, in one form thereof, a system for the long-term storage and high-speed retrieval of images stored on imaging substrates. The images are stored by utilizing semiconductor fabrication techniques such that, with magnification, the images are visible to the human eye. Datasets from print, digital or other media are converted to an image and formed onto a semiconductor substrate. The images are transferred to specific predetermined locations on the imaging substrate by photolithography tools and nanotechnology fabrication techniques.

An embodiment of this invention combines archival and storage in a single package The archived documents or data are stored as bit mapped images on a durable wafer of silicon or other suitable material. In addition, the wafer is fabricated with a memory, such as a flash memory, eprom or eeprom, which holds a copy of the archived documents or data. The memory on the wafer is accessible via a universal serial bus or any other suitable data access means. The memory can quickly provide real time, near instantaneous access to a copy of the archived data. In this way, a user can access and search the documents or data on the memory in a customary manner. In the event the data in the memory is disrupted, the archived documents or data can be accessed optically to recreate an electronic memory.

It is understood that saving archival documents and data on a wafer such as those described in U.S. patent application Ser. No. 11/956,911 filed Dec. 14, 2007, the contents of which are incorporated by reference, can be used. It is further understood that conventional and well known techniques to store and access data and images of documents on flash memory drives, eproms and eeproms are suitable.

The stored images are retrievable by two distinct methods. In the simplest form, the optical images are retrievable by magnification alone. In another embodiment the optical images are retrieved by use of a first software program. The first software program searches for the user's queries in the electronic database and sends the metadata relating to that particular image to the image reader. The image reader scans the location image. The image reader then transmits the location information from the location image to the system to drive either the optics over the imaging substrate or the imaging substrate itself to the appropriate location relative to the optical system. The desired image is then displayed for the user.

The electronically stored images are retrievable by use of a data cord and a computer. In an alternative embodiment the data is transmitted to a computer through a wireless device such as by IR, RF, Bluetooth or traditional wireless networking technology. Once linked, the computer can access digital replicas of the images located optically on the substrate.

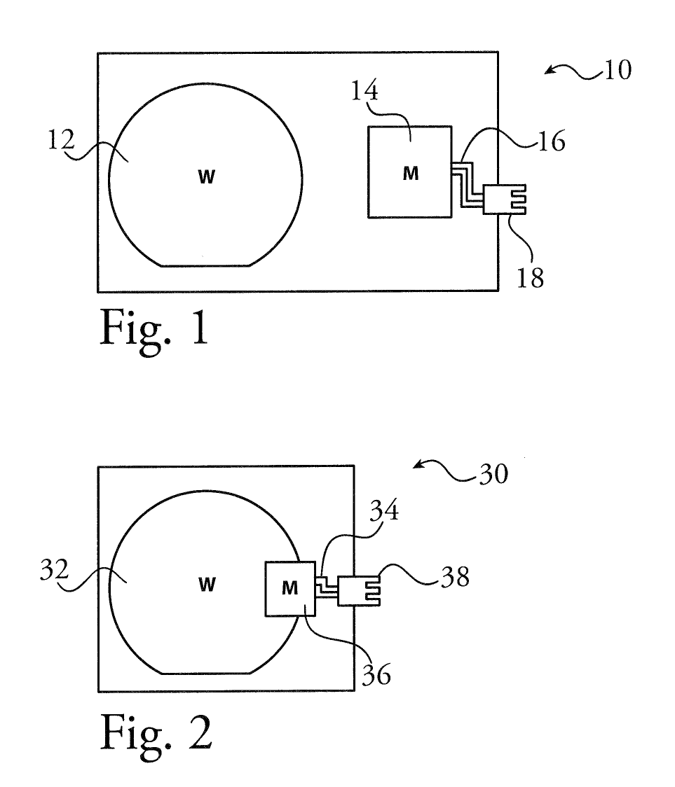

Turning to FIG. 1, a memory device 10 has a wafer fiche 12 that holds documents of data and is made in accordance with States patent application Ser. No. 11/956,911 filed Dec. 14, 2007, the contents of which are incorporated by reference. Also included in the device is a memory 14 which may be any suitable type, including and not limited to a flash memory, eprom, eeprom, or a miniature disk drive. The memory 14 has IN/OUT connections lines 16 coupled to an I/O plug 18. The I/O plug may be a conventional universal serial bus connector. The same documents or data are stored on the wafer fiche 12 and the memory 14. If a user wants to quickly access the stored data, the user connects the I/O connector 18 to a suitable computer (not shown) which uses a conventional memory access program to read the memory 14. If for any reason the memory 14 is corrupted or otherwise not accessible, the wafer fiche 12 holds an archive copy of the documents or data. The wafer fiche is read by an optical reader and the results can either be stored in the memory 14 or a new memory can be substituted in case memory 14 is inoperative or otherwise impaired.

Turning to FIG. 2, a memory device 10 has a wafer fiche 32 that holds documents of data and is made in accordance with States patent application Ser. No. 11/956,911 filed Dec. 14, 2007. Also included on the wafer fiche 32 is a memory 34 which may be any suitable type, including and not limited to a flash memory, eprom, eeprom, or any other type of memory that can be manufactured on the silicon wafer. The memory 36 has IN/OUT connections lines 36 coupled to an I/O plug 38. The I/O plug may be a conventional universal serial bus connector. The same documents or data are stored on the wafer fiche 32 and the memory 34. If a user wants to quickly access the stored data, the user connects the I/O connector 38 to a suitable computer (not shown) which uses a conventional memory access program to read the memory 34. If for any reason the memory 14 is corrupted or otherwise not accessible, the wafer fiche 32 holds an archive copy of the documents or data. The wafer fiche is read by an optical reader and the results can either be stored in a new memory formed on a new wafer fiche which is processed to hold a copy of the original archived documents or data.

Those skilled in the art understand that the memory devices 10, 30 can be networked and thus are always accessible to users. As such, documents and data normally sent to long term, off-site storage, can be retained and are accessible anytime. The embodiments of the invention virtually eliminate the need for off-site storage of documents. With the embodiments of the invention all records can be retained at the customary place of business. The embodiments of the invention provide not only archival storage and long term durability of documents and data, but also short term rapid access to those documents and data. As such, one paper records are stored on the combined wafer fiche and memory and the paper copies can be destroyed or recycled. This feature of the invention saves resources by recycling paper so that fewer trees are harvested for paper and fewer warehouses are needed to store paper records.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A memory device with a first memory for holding an archival copy of documents or data and an electronic memory holding a duplicate copy of the same documents or data.

2. The memory device of claim 1, wherein said first memory device is a silicon wafer.

3. The memory device of claim 1, wherein said electronic memory is a flash memory.

4. The memory device of claim 2, wherein said silicon wafer contains a human readable image of the documents or data.

5. The memory device of claim 1, wherein said electronic memory is connectable to a computer via a USB port.
